(19) United States
(12) Patent Application Publication
(10) Pub. No.: US 2014/0241110 A1
(43) Pub. Date: Aug. 28, 2014

(54) FLUIDIC CHANNEL DEVICE, METHOD FOR MIXING FLUIDS, FLUID CONTROL DEVICE, AND LIQUID CONTROL SYSTEM

(71) Applicant: Eishi Igata, Utsunomiya-shi (JP)

(72) Inventor: Eishi Igata, Utsunomiya-shi (JP)

(73) Assignee: CANON KABUSHIKI KAISHA, Tokyo (JP)

(21) Appl. No.: 14/237,553

(22) PCT Filed: Jul. 25, 2012
(86) PCT No.: PCT/JP2012/069534

§ 371 Date: Mar. 28, 2014

(30) Foreign Application Priority Data
Aug. 11, 2011 (JP) 2011-175900

(51) Int. Cl. B01F 5/00

(52) U.S. Cl. CPC B01F 5/00
USPC 366/340

(57) ABSTRACT

To make plural kinds of fluids in a microfluidic channel be mixed efficiently.

Provided is a fluidic channel device which includes: at least two fluidic channels through which fluids flow; a joining fluidic channel at which the fluids flowing in the two fluidic channels are made to join to each other and form an interface therebetween; and a mixing fluidic channel disposed in the downstream of the joining fluidic channel and having a cross section with respect to a flowing direction which cross section is longer than that of the joining fluidic channel in a direction in which the interface becomes large.

### TECHNICAL FIELD

The present invention relates to a fluidic channel device having a fluidic channel for mixing plural kinds of fluids. The present invention also relates to a method for mixing fluids, a fluid control device, and a liquid control system.

### BACKGROUND ART

In analytical chemistry, it is a basic matter to acquire data about required information, including concentration and constituents, so as to verify progresses and results of chemical and biochemical reactions. Various apparatuses and sensors for acquiring such data have been invented. There is a concept called a micro total analysis system (μ-TAS) or a lab-on-a chip of implementing all the processes to acquire the required data on a micro device using miniaturized apparatuses and sensors. This is a concept of acquiring, for example, concentration of constituents included in a final chemical compound or a sample through processes including sample refining and chemical reaction, by causing obtained materials and unrefined samples to pass through a fluidic channel in the micro device. The micro device which controls these analysis and reaction is often called a microfluidic device because a very small amount of solutions or gas is used in the microfluidic channel device.

As compared with desktop-sized analyzers of the related art, the amount of fluid used in the microfluidic device is small. Therefore, shorter reaction time is expected which is caused by reduced amount of necessary reagents and reduced amount of materials to be analyzed. As advantages of the microfluidic device are increasingly recognized, techniques related to the μ-TAS have begun to attract attention.

Characteristics that have not been recognized are identified as a result of reduction in size of the device, i.e., from the desktop-sized device to a micro device. An example thereof is promotion of mixture of fluids caused only by raised specific interfacial area and molecular diffusion. Such a phenomenon that may be ignored in the desktop-sized analyzers is important in the micro device. Particularly, although it is important to mix plural solutions efficiently in a fluidic device during a chemical reaction, a phenomenon of reduction in speed of mixture will occur due to formation of a laminar flow by plural solutions flowing together in the same direction in a micro fluidic channel.

PTL 1 discloses a method for promoting mixture of fluids in a micro fluidic channel. In the disclosed method, a laminar flow having a contact surface parallel to the depth direction is formed in a deep-groove micro reactor having a fluidic channel dimensioned to be larger in depth than width. In the micro reactor of PTL 1, the two fluidic channels before joined to each other are deep groove fluidic channels and the fluidic channel after the joining also have the same depth.

Therefore, it is difficult to precisely control the amount of the fluids at the time of joining and a mixing ratio in the direction along an interface is not always constant.

Such a problem may be ignored from the viewpoint of reaction and synthesis in large amount in a reactor. However, in the field of, for example, μ-TAS in which an inspection reaction process of PCR and so forth is subsequently carried out, control of the amount of fluids is sometimes difficult: therefore, a more suitable form is demanded.

### CITATION LIST

### Patent Literature

PTL 1 Japanese Patent Laid-Open No. 2007-050320 (FIG. 4B)

### SUMMARY OF INVENTION

The present invention provides a fluidic channel device which requires no active manipulation of a fluid flowing in a fluidic channel is capable of being fabricated easily, and promoting mixture of fluids with a mixing amount being controlled. The present invention also provides a method for mixing fluids using the fluidic channel device. A fluidic channel device according to the present invention includes a substrate on which a groove for forming a fluidic channel is provided, the fluidic channel device including: at least two fluidic channels through which fluids flow; a joining fluidic channels which makes the fluids flowing in the two fluidic channels join to each other and form an interface therebetween; and a mixing fluidic channel disposed in the downstream of the joining fluidic channel, wherein: a cross sectional area of the mixing fluidic channel with respect to a flowing direction is larger than that of the joining fluidic channel along a direction in which the interface of the fluids becomes large; and the direction in which the interface becomes large corresponds to a direction in which the groove of the substrate becomes deep. A method for mixing fluids using a fluidic channel device having at least two fluidic channels and a joining fluidic channel which makes fluids flowing in the two fluidic channels join to each other, wherein the fluidic channel device includes a substrate on which a groove for forming a fluidic channel is provided, the method including: introducing fluids into the two fluidic channels; making an interface between the fluids be formed in the joining fluidic channel along a direction in which the groove of the substrate becomes deep; and making the interface become large in the downstream of the joining fluidic channel along a direction in which the groove becomes deep. According to the present invention, after making plural kinds of fluids join to each other in a joining fluidic channel, a layered flow may be formed such that a contact interface is increased along its surface direction in an enlarged fluidic channel in the downstream. Therefore, a fluidic channel device in which control of the amount of each fluid at the time of joining is easy and fluids are mixed promptly may be provided.

### BRIEF DESCRIPTION OF DRAWINGS

FIG. 1 is a conceptual diagram illustrating a principle of a fluidic channel device of the present invention.

FIGS. 2A and 2B are diagrams illustrating an embodiment of a fluidic channel device of the present invention.

FIG. 3 is a conceptual diagram of an embodiment of mixture of two kinds of fluids using the fluidic channel device of the present invention.

FIGS. 4A to 4D are cross-sectional views of a fluidic channel of the embodiment of the mixture of two kinds of fluids using the fluidic channel device of the present invention.

FIG. 5 is a conceptual diagram of an embodiment of the mixture of two kinds of fluids using a fluidic channel device of the present invention.

FIGS. 6A to 6C are cross-sectional views of a fluidic channel of an embodiment of mixing of two kinds of fluids using a fluidic channel device of the present invention.

FIG. 7 is a conceptual diagram of a fluidic channel of an embodiment of mixture of three kinds of fluids using a fluidic channel device of the present invention.

FIGS. 8A to 8D are cross-sectional views of a fluidic channel of an embodiment of mixing of three kinds of fluids using a fluidic channel device of the present invention.

FIG. 9 is a conceptual diagram of an embodiment in which four or more fluids are mixed using a fluidic channel device of the present invention.

FIG. 10 is a diagram illustrating a fluid control device which carries out fluid control using a fluidic channel device of the present invention.

FIG. 11 is a flowchart of a method for transferring fluids using a fluid control device.

### DESCRIPTION OF EMBODIMENTS

Hereinafter, the present invention will be described in detail. Unless otherwise noted regarding the directions X, Y and Z, directions of fluidic channels formed on a substrate are defined as follows: a direction of a plane parallel to a substrate plane is a fluidic channel width direction; and a direction of a path vertical to the substrate plane is a fluidic channel height direction.

A device according to the present invention includes: at least two fluidic channels through which fluids flow; a joining fluidic channel at which the fluids flowing in the two fluidic channels are made to join to each other and form an interface therebetween; and a mixing fluidic channel disposed in the downstream of the joining fluidic channel and having a cross section with respect to a flowing direction which cross section is longer than that of the joining fluidic channel in a direction in which the interface becomes large.

A method according to the present invention is a method for mixing fluids using a fluidic channel device having at least two fluidic channels and a joining fluidic channel which makes fluids flowing in the two fluidic channels join to each other, the method including: introducing fluids into the two fluidic channels; forming an interface between the fluids in the joining fluidic channel; and making the interface become large in the downstream of the joining fluidic channel.

A configuration is desirable in which the fluidic channel device is configured to include a first substrate on which a groove for forming the mixing fluidic channel is provided; and the mixing fluidic channel includes a fluidic channel enlargement region which increases its dimension in the depth direction of the groove as the distance from the joining fluidic channel becomes greater. Further, a configuration is desirable in which a top surface of the fluidic channel enlargement region corresponds to a bottom surface of a second substrate.

Further, it is desirable that the device according to the present invention is configured as a fluidic channel device in which: a first fluidic channel is formed in the first substrate and a second fluidic channel is formed in the second substrate; and the second substrate and the first substrate are joined to each other in a manner that an end of the first fluidic channel is connected to the second fluidic channel to form a joining fluidic channel in the second substrate, wherein an end of the joining fluidic channel is connected to a substantial end of the fluidic channel formed in the first substrate.

Alternatively, it is desirable that the device according to the present invention is a microfluidic device in which: a first fluidic channel which includes a branching is formed in the first substrate and a second fluidic channel which includes a branching is formed in the second substrate; one end of the first fluidic channel is connected to the second fluidic channel and forms a second joining fluidic channel in the second substrate; one end of the second fluidic channel is connected to the first fluidic channel and forms a first joining fluidic channel in the first substrate; and the second substrate and the first substrate are joined to each other in a manner that an end of the first joining fluidic channel is connected to the second joining fluidic channel, wherein an end of the second joining fluidic channel is connected to a substantial end of the fluidic channel formed in the first substrate.

It is desirable that a bending fluidic channel for changing a direction of the interface is provided in the joining fluidic channel. Plural fluidic channels and supply inlets connected to the fluidic channels may be integrated at one side of the mixing fluidic channel in which deep grooves are formed. Since the other side may be used as a region in which a fluidic channel after the mixture is formed, a further integrated structure may be provided.

In a joining process in fabrication of the fluidic channel device of the present invention, in consideration of a manufacture error in the joining process, a micro fluidic channel of which height is greater than width in its cross section is suited for joining while keeping its cross sectional area as compared with a microfluidic channel of which width is greater than height.

The fluidic device of the present invention is suitably implemented in a microfluidic device provided with a microfluidic channel of which size of at least one of width, height and length is in the μm order, i.e., 0.1 to 500 μm.

For example, a microfluidic channel which is 50 μm in width and 20 μm in height has a cross sectional area of 95 μm² if the microfluidic channel is pressed in its height direction by 1 μm by the pressure in the joining process. In contrast, a microfluidic channel which is 20 μm in width and 50 μm in height has a cross sectional area of 98 μm², which is closer to the intended cross section of 100 μm² if the same manufacture error exists. Therefore, if the microfluidic channel is fabricated from, for example, a plastic material, it is advantageous that the fluidic channel is greater in height than in width from the viewpoint of keeping the cross sectional area of the fluidic channel. In the method for promoting mixture by forming a multi-layer flow described above promotes mixture by forming the plural layered flows such that interfaces are formed along the width direction of the cross section of the microfluidic channel to increase the interfacial area between the layered flows. However, this method is not suitable for the mixture in a microfluidic channel of which the height is greater than the width because the layered flow is formed in the direction along which the interfacial area is small.

In the present invention, in which a laminar flow is formed in a microfluidic channel, whether the fluids flowing in a specific fluidic channel form a laminar flow or a turbulent flow may be estimated in accordance with the Reynolds number (Re) and is determined by Re=UL/v. Here, U represents the characteristic velocity, L represents the characteristic length and v represents kinematic viscosity. Although there is no numerical value as a strict boundary, if the Reynolds number is substantially lower than 2000, it is generally considered that the fluid in the system forms a laminar flow. It is recognized that the Reynolds number is small in microfluidic channels: generally lower than 100 and often 1 or less. Therefore, it may be considered that the flows of fluids form a laminar flow in a microfluidic channel. When plural kinds of fluids are introduced into the same microfluidic channel, the fluids flow without being mixed except at regions near their interfaces. Unless otherwise noted, the size of the fluidic channel of the present invention is determined such that the fluids flowing in the fluidic channel form a laminar flow because of the small Reynolds number.

Mixture of the fluids in the microfluidic channel depends on the molecular diffusion because physical agitation of fluids in the fluidic channel is not easy in such a very small place and because influence of gravity is negligibly small. According to the Einstein-Smoluchowski theory, a relationship of diffusion time (t) of molecules in one dimension, diffusion length (σ) and a diffusion coefficient (D) of the fluid is t=σ²/2D. If the fluidic channel width of a certain microfluidic channel is represented by w, the diffusion time is proportional to w²/D.

Now, it is assumed that two kinds of fluids are flowing each having a cross section of 50 μm in width and 20 μm in height in a microfluidic channel having a cross section of 100 μm in width and 20 μm in height. Since the longest distance necessary for the molecular diffusion constituting each fluid is 50 micrometers, time necessary for the movement of the molecules is 12.5 seconds when the diffusion coefficient of the molecules is 1×10⁻⁶ cm²/s. In contrast, in the microfluidic channel having the same cross sectional area of that described above but 20 μm in width and 100 μm in height, time necessary for the movement of molecules when two kinds of fluids are flowing each with a cross section of 10 μm in width and 100 μm in height is 0.5 seconds. That is, the distance necessary for the diffusion is reduced to 1/5 and therefore the time necessary for the movement of the molecules is reduced to 1/25.

The amount of molecules which permeate the interface formed by the layered flow is determined by J×A×t, where J represents the flux, A represents the cross section and t represents time. Since a larger amount of molecules permeating the interface promotes mixture, the mixing efficiency is proportional to the cross sectional area of the interface. For example, in a microfluidic channel which is 20 μm in width, 100 μm in height and 100 μm² in cross section, when two kinds of fluids are flowing alternately in a four-layer flow each layer has a cross section of 5 μm in width and 100 μm, time required for movement of molecules is 0.125 seconds where the diffusion coefficient of the molecules is 1×10⁻⁶ cm²/s. The interfacial area of the four-layer flow is three times as large as that of a two-layer flow flowing in a microfluidic channel of the same cross section: therefore, the difference in the interfacial area is included in the mixing time.

That is, it is important for the mixture at high efficiency to shorten the diffusion length necessary for the mixture and keep the interfacial area large by forming a multi-layer flow.

The present invention applies the above-described principle: a multi-layer flow is formed in the direction in which the interfacial area is increased in the microfluidic channel and plural kinds of fluids are mixed in the microfluidic channel. In the following description, a layered flow formed by two flowing fluids is referred to as a two-layer flow and a layered flow formed by three flowing fluids is referred to as a three-layer flow, and so forth.

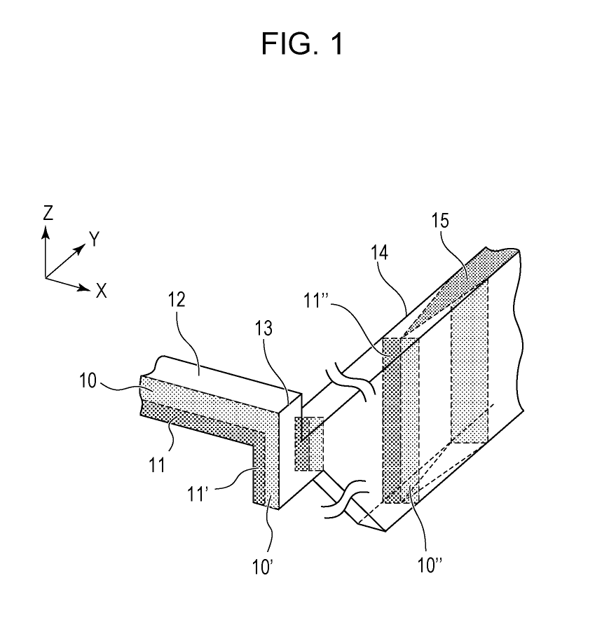

FIG. 1 is a conceptual diagram illustrating an embodiment of the device of the present invention to form a layered flow with an increased interfacial area. Hereinafter, the embodiment will be described in detail with reference to FIG. 1.

In the device of the present embodiment, a joining flow path 12 is bent at substantially a right angle at an end 13 thereof and is connected to a mixing fluidic channel 14 while being displaced in the Z direction. The joining fluidic channel 12 is dimensioned such that a layered flow is formed when plural kinds of fluids are joined to each other and that mixture of the fluids is not easily promoted at areas other than a contact interface.

Assuming that the X direction corresponds to a fluidic channel width and the Z direction corresponds to a fluidic channel height, an aspect ratio between the fluidic channel width and the fluidic channel height of the mixing fluidic channel 14 disposed downstream of the joining fluidic channel 12 is higher than that of the joining fluidic channel 12.

That is, since the mixing fluidic channel 14 of which cross section to a flowing direction (i.e., the Y direction) is longer than that of the joining fluidic channel along a direction in which the interface is increased (i.e., the Z direction) is located downstream, the area of the contact interface of the layered flow may be increased to promote the mixture.

Desirably, at a portion at which the joining fluidic channel 12 and the mixing fluidic channel 14 join each other, an fluidic channel enlargement region is formed as a part of the mixing fluidic channel 14 as illustrated in FIG. 1: the fluidic channel enlargement region changes the fluidic channel height gradually such that the aspect ratio becomes gradually high as the distance from the end 13 becomes greater. Such a structure may be fabricated in the following manner: the joining fluidic channel 12 is formed on one substrate; the mixing fluidic channel 14 is formed on the other substrate; the end 13 is made to correspond to a position of a substantial end of the mixing fluidic channel 14; and the two substrates are made to join to each other such that the joining fluidic channel 12 and the mixing fluidic channel 14 are substantially at a right angle with each other.

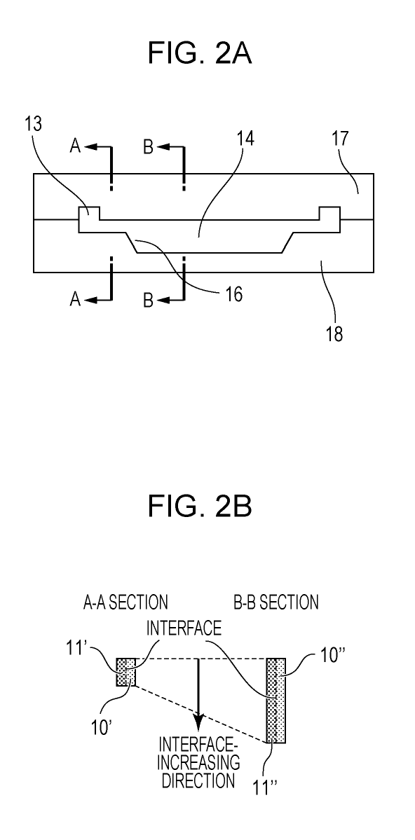

FIGS. 2A and 2B illustrate an exemplary fluidic channel device of the present embodiment formed by joining two substrates. A first substrate 18 provided with the mixing fluidic channel 14 and a second substrate provided with a part of the joining fluidic channel 12 are made to join to form the fluidic channel device. The fluidic channel enlargement region 16 is formed at a portion where the mixing fluidic channel 14 and the joining fluidic channel 12 are joined together. The fluidic channel enlargement region 16 increases its dimension in the depth direction of a groove as the distance from the joining fluidic channel 12 becomes greater.

FIG. 2A is a cross-sectional view of the fluidic channel device of FIG. 1 seen from the X direction, and FIG. 2B schematically illustrates cross sections along lines A-A and B-B of FIG. 2A.

In the present embodiment, a fluid 10 and a fluid 11 may be mixed to each other and form a two-layer flow laminated along the Z direction. The two-layer flow first flows in the X direction through the joining fluidic channel 12. At the end 13 of the joining fluidic channel 12, the fluid 10 and the fluid 11 turn at substantially a right angle on the negative side of the Z direction and become a fluid 10′ and a fluid 11′, respectively. The fluid 10′ is situated further toward the positive side of the X direction than the fluid 11′ and thereby the two-layer flow is kept. The fluid 10′ and the fluid 11′ flow in the substantial two-layer form through the mixing fluidic channel 14 which extends in the Y direction. At a position at which the fluidic channel height becomes greater than the fluidic channel width of the mixing fluidic channel 14, the fluid 10′ and the fluid 11′ form a fluid 10″ and a fluid 11″, respectively. Therefore, the fluid 10″ and the fluid 11″ have a contact interface larger than that of the fluid 10 and the fluid 11 in the joining fluidic channel 12 and, therefore, are mixed at higher efficiency. The process of mixture is illustrated by the reference numeral 15 in FIG. 1. That is, as illustrated in FIG. 2B, the cross section of the mixing fluidic channel 14 to the flowing direction is longer than that of the joining fluidic channel 12 along the direction in with the interface is increased (i.e., the Z direction). The width of the interface in the normal direction (i.e., the X direction) is desirably, but not necessarily, constant from the viewpoint of fabrication.

In FIG. 1, the fluid 10 and the fluid 11 form a two-layer flow laminated in the Z direction and flow through the joining fluidic channel 12. The two-layer flow may be formed in the following manner. The joining fluidic channel 12 in which the fluid 10 flows is formed on one substrate and a microfluidic channel to which the fluid 11 is supplied is formed on the other substrate: these substrates are made to join so that the microfluidic channel crosses the joining fluidic channel 12. Desirably, the microfluidic channel which supplies the fluid 11 and the mixing fluidic channel 14 are formed on the same substrate. The ratio between the fluidic channel width and the fluidic channel height may be determined arbitrarily: however, it is desired that the fluidic channel width is substantially not greater than 100 μm in order to reduce the area with respect to the entire microfluidic device. A slight amount of fluid 10 and the fluid 11 are mixed on the contact interface formed in the joining fluidic channel 12. If the fluid 10 and the fluid 11 are intended to be mixed uniformly in the mixing fluidic channel 14, the fluid 10 and the fluid 11 may be mixed in a small amount in the joining fluidic channel 12.

The material of the device which forms the joining fluidic channel 12 and the mixing fluidic channel 14 may be glass, ceramic, semiconductor, or combinations thereof: however, the material is not limited to the same. Plastic materials are useful to provide a higher aspect ratio between the flow path width and the fluidic channel height of the mixing fluidic channel 14. This is because plastic materials may easily form a fluidic channel by less expensive methods, such as machining and injection molding, even if the fluidic channel height is greater than the fluidic channel width.

The fluid 10 and the fluid 11 are not particularly limited as long as being capable of mixing with each other. The fluid 10 and the fluid 11 may have the same principal constituent. For example, the principal constituent of the fluid 10 and the fluid 11 is water, but the fluid 10 and the fluid 11 each include a water-soluble substance. Reaction of the substances starts when the fluid 10 and the fluid 11 are mixed with each other. Alternatively, the fluid 10 may include a water-soluble sample and the fluid 11 may be a reagent including water as a principal constituent.

The method for forming a layered flow in the microfluidic channel such that the layered flow is formed in the direction in which the contact interface area becomes large has been described. Hereinafter, a method for forming a multi-layer flow will be described with reference to an embodiment.

### Structure of Apparatus Using Fluid Device

Details of an apparatus in which the fluidic channel device of the embodiment described above and a method for transferring the fluid will be described below.

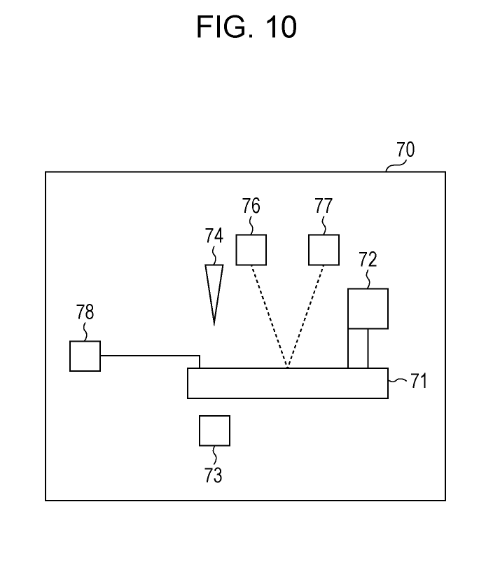

FIG. 10 is a diagram illustrating a structure of a fluid transfer apparatus according to the present invention.

A fluid transfer apparatus 70 is provided with a pressure unit 72 and a fluid detecting unit 73. The pressure unit 72 produces positive or negative pressure in the fluidic channel of the fluidic channel device 71. The fluid detection unit 73 detects exposure of bottom surfaces of first and second inlets of the fluidic channel device from a fluid level. The pressure unit 72 is a pump unit, such as a syringe pump, which is connected to, for example, a discharge hole communicating with the fluidic channel of the fluidic channel device 71. The pressure unit 72 produces pressure in the fluidic channel. An exemplary fluid detecting unit detects existence of the fluid by an optical unit which detects reflection on the bottom surface or an electrical unit, such as a resistor body.

The reference numeral 74 denotes a fluid introduction unit, such as a pipet, and 71 denotes a fluid device.

A light irradiation unit 76, such as laser, and a light detection unit 77, such as a CCD, are reaction detection units. Further, a placing portion (not illustrated) on which the fluidic channel device 71 is placed and a power supply 78 which is electrically connected to a heating member provided in the fluidic channel device and other components are provided. A control unit (i.e., a computer) which controls these components may be incorporated in the apparatus.

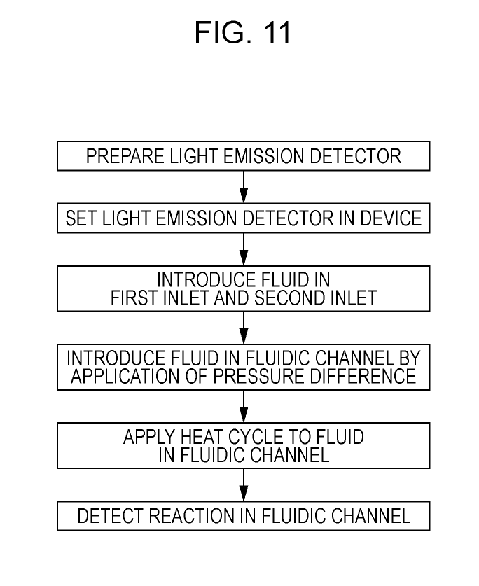

FIG. 11 is a flowchart of a method for transferring the fluid using the apparatus described above.

First, a fluidic channel device 71 provided with the first and second inlets of the embodiment is prepared.

Next, the fluidic channel device is placed on a carrier portion of the apparatus 70. Fluid is introduced into an introduction space of the fluidic channel device by the fluid introduction unit 74 through the first inlet and the second inlet.

Then, pressure difference is applied to the fluidic channel by a pressure generation unit and the fluids held at the inlets are mixed to each other in the fluidic channel by being made to pass through the joining fluidic channel.

Power is supplied to the heating member of the fluidic channel device from the power supply 78, and temperature control of the fluidic channel into which the fluids have been introduced is carried out. The temperature control includes, for example, application of temperature cycle for PCR and rise of temperature for thermal fusion measurement.

Reaction in the fluidic channel is detected at the same time with or after the temperature control by the reaction detection unit. As a result of the detection, existence or an amount of the reaction may be determined and reaction in the fluidic channel may be analyzed.

### EXAMPLES

Hereinafter, the present invention will be described in further detail with reference to examples. The following examples are provided to describe the present invention in more detail and thus the embodiments are not limited to the following examples.

### Example 1

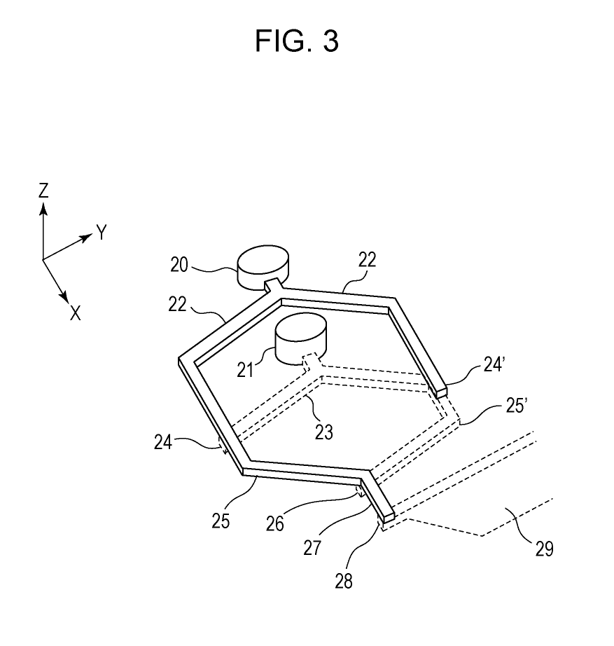

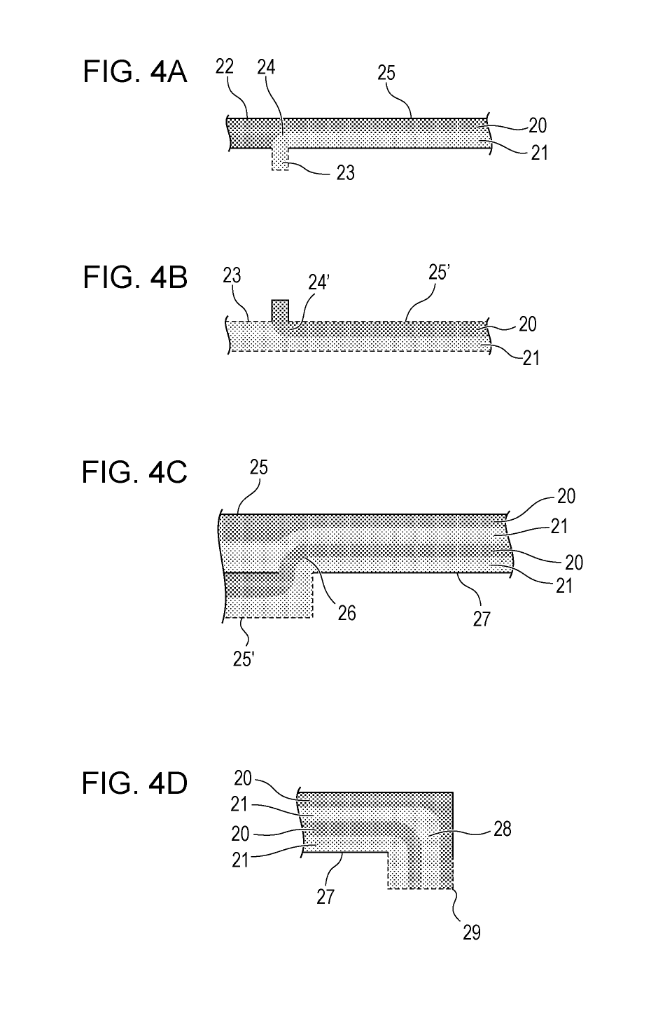

In Example 1, a method of the present invention for forming a multi-layer flow in a microfluidic channel and then forming a multi-layer flow in the direction in which a contact interface area is increased by turning the direction of the layered flow will be described with reference to FIGS. 3 to 4D.

FIG. 3 is a perspective view illustrating the inlet and the fluidic channel in the micro fluid device. The fluidic represented by a solid line is a fluidic channel produced on the second substrate, and the fluidic channel represented by a dashed line is a fluidic channel produced on the first substrate. The second substrate and the first substrate are joined such that a groove formed on the second substrate corresponds to a flat portion of the first substrate, or a groove formed on the first substrate corresponds to a flat portion of the second substrate. Then, a flow path is formed on the second and first substrates. The fluidic channel produced on the second substrate and the fluidic channel produced on the first substrate cross each other at the positions 24, 24′, 26 and 28 in FIG. 3. At these positions, the fluidic channels are connected while being displaced in the height direction.

A fluid 20 included in the second inlet flows through a fluidic channel 22 which includes branching. A fluid 21 included in the first inlet flows through a fluidic channel 23 which includes branching. The fluid 20 and the fluid 21 are capable of being mixed with each other. The fluidic channel 23 joins to the fluidic channel 22 at a junction 24. At this time, the fluid 21 flowing in the fluidic channel 23 joins to the fluid 20 at a junction 24 while being displaced on the positive side of the Z direction. In a joining fluidic channel 25, the fluid 20 and the fluid 21 form a two-layer flow so that the fluid 20 flows on the positive side of the Z direction. FIG. 4A is a ZX cross-sectional view of the junction 24.

The fluid 20 and the fluid 21 which flow in the fluidic channel 22 and the fluidic channel 23, respectively, toward a junction 24′ join to the fluid 21 at the junction 24′ while the fluid 20 being displaced on the negative side of the Z direction and then flow in a joining fluidic channel 25′. The fluid 20 and the fluid 21 flowing through the junction 24′ and the joining fluidic channel 25′ are illustrated in FIG. 4B as a ZX cross-sectional view near the junction 24′. Since the fluid 20 joins to the fluid 21 while being displaced on the negative side of the Z direction from the fluidic channel 22, these fluids 20 and 21 form a two-layer flow in which the fluid 20 flows on the positive side of the Z direction in the joining fluidic channel 25′.

The joining fluidic channel 25 and the joining fluidic channel 25′ join to each other at a further junction 26. The flow of the fluid at this time is illustrated in FIG. 4C as a ZX cross-sectional view. Since the two-layer flow which flows in the joining fluidic channel 25′ joins to the two-layer flow which flows in the joining fluidic channel 25 while being displaced on the positive side of the Z direction, these two-layer flows form a four-layer flow in a joining fluidic channel 27. The direction in which the layered flow is formed in the joining fluidic channel 25 and the joining fluidic channel 25′ is not changed even after passing through the junction 26. An angle formed on an XY plane when the joining fluidic channel 25 and the joining fluidic channel 25′ join to each other should not be 180 degrees. This is because there is a possibility that the layered flow flowing in each fluidic channel is not kept if the angle is 180 degrees. The angle is desirably not smaller than 0 degrees and not greater than about 45 degrees.

The four-layer flow flowing through the joining fluidic channel 27 is connected to a mixing fluidic channel 29 at a substantially right angle with at an end 28. The flow of the fluid in this state is illustrated in FIG. 4D. The four-layer flow which flows in the joining fluidic channel 27 is displaced on the negative side of the Z direction at the end 28. This change the layered flow laminated in the Z direction into a layered flow laminated in the X direction. The layered flow changed in the flowing direction flows in the mixing fluidic channel 29 in the Y direction while keeping the layer in the X direction. Since the mixing fluidic channel 29 is greater in width (X direction) than in height (Z direction), the area of the contact interface formed in the layered flow is large. Therefore, formation of the multi-layer flow while keeping the interfacial areas large may greatly promote the mixture of the fluids.

For the adjustment of the a mixing ratio of the fluid 20 and the fluid 21, the flow rate of these fluids 20 and 21 may be set arbitrarily by adjusting the pressure applied to the second and first inlets. Regarding the mixing ratio, the amount of the fluid introduced into the mixing fluidic channel 29 may be recognized by monitoring the width of each layered flow in the mixing fluidic channel 29.

In the present invention, as described above, formation of a multi-layer flow in the direction in which an interfacial area increases may be achieved by joining two substrates even with the displacement in the Z direction. A method for increasing the interfacial area may include increasing the width of the joining fluidic channel 27 on the XY plane: however, this method increases the area of the joining fluidic channel 27 in the direction of the XY plane and thereby is not suitable in integration of the device. The mixing fluidic channel 29 which is greater in width than height, such as that of the present invention, has an effect that the area of the fluidic channel in the direction of the XY plane necessary for the mixture is reduced and, therefore, a device further suitable for integration may be produced.

### Example 2

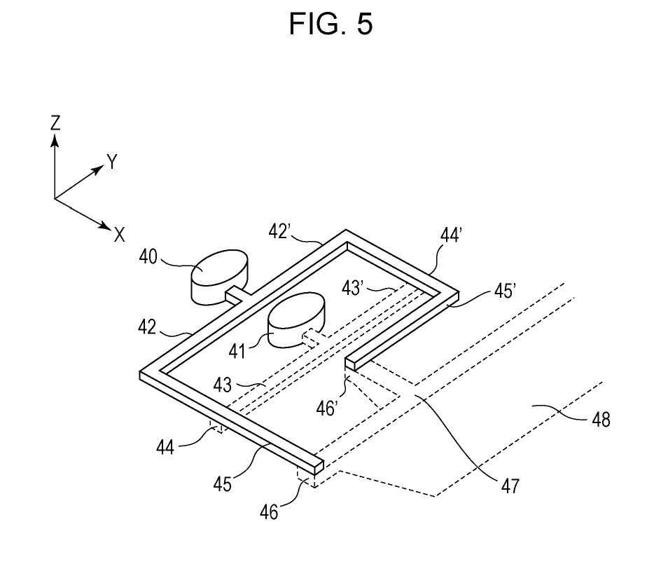

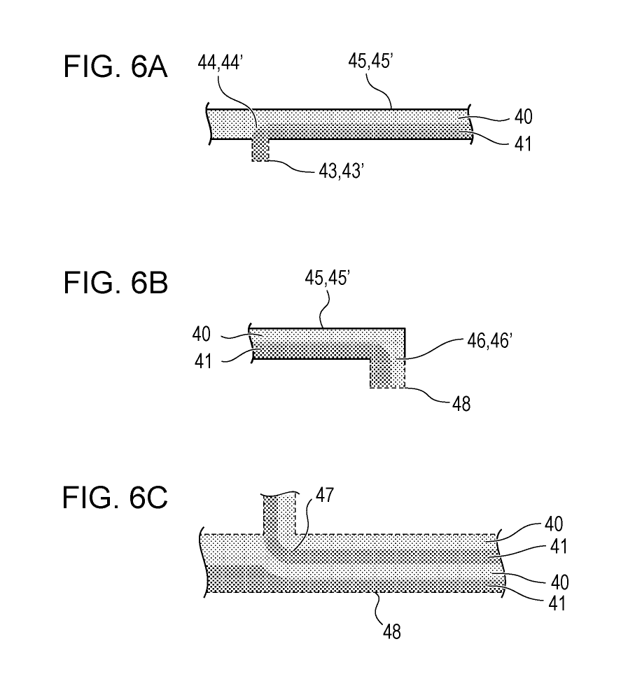

In Example 2, a method of the present invention for forming a multi-layer flow in a mixing fluidic channel and then forming a multi-layer flow in the direction in which a contact interface area is increased will be described with reference to FIGS. 5 to 6C.

FIG. 5 is a perspective view illustrating inlets and fluidic channels in a microfluidic device. The fluidic channel represented by a solid line is a fluidic channel produced on the second substrate, and the fluidic represented by a dashed line is a fluidic channel produced on the first substrate. The second substrate and the first substrate are joined such that a groove formed on the second substrate corresponds to a flat portion of the first substrate, or a groove formed on the first substrate corresponds to the flat portion of the second substrate. Then, a fluidic channel is formed on the second and first substrates. The fluidic channel produced on the second substrate and the fluidic channel produced on the first substrate cross each other at the positions 44, 44′, 46 and 46′ in FIG. 5. At these positions, the fluidic channels are connected while being displaced in the height direction.

A fluid 40 included in a second inlet is branched into a fluidic channel 42 and a fluidic channel 42′. A fluid 41 included in a first inlet is branched into a fluidic channel 43 and a fluidic channel 43′. An end of the fluidic channel 43 is connected to the fluidic channel 42 and an end of the fluidic channel 43′ is connected to the fluidic channel 42′. The position at which these fluidic channels are connected to one another is a junction 44. The fluid 41 joins to the fluid 40 while being displaced on the positive side of the Z direction at the junction 44. This process is illustrated in FIG. 6A. A two-layer flow in which the fluid 40 is located further toward the positive side of the Z direction than the fluid 41 is formed in a joining fluidic channel 45. Similarly, a two-layer flow in which the fluid 41 joins to the fluid 40 at the junction 44′ and the fluid 40 is located further toward the positive side of the Z direction than the fluid 41 is formed in a joining fluidic channel 45′.

The fluid flowing in the joining fluidic channel 45 is displaced at an end 46 on the negative side of the Z direction as illustrated in FIG. 6B and the direction in which the layered flow is laminated is changed from the Z direction into the X direction. Then the layered flow flows to a junction 47 of the mixing fluidic channel 48 while keeping the direction of this layered flow. The fluid flowing in the joining fluidic channel 45′ is displaced at an end 46′ on the negative side of the Z direction and the direction in which the two-layer flow is laminated is changed from the Z direction into the Y direction. Then the two-layer flow flows to a junction 47 of the mixing fluidic channel 48 while keeping the direction of this layered flow.

The junction 47 is disposed within the mixing fluidic channel 48, and is a junction at which no displacement in the Z direction is carried out. That is, the flow from the ends 46 and 46′ form a two-layer flow laminated in the X direction. Since the flow immediately before reaching the junction 47 is a two-layer flow, a four-layer flow is formed when the two-layer flow passes through the junction 47 as illustrated in FIG. 6C which is a cross-sectional view along the XY plane. Since the four-layer flow flowing in the mixing fluidic channel 48 is formed in the direction in which the contact interface area is large, the fluids are speedily mixed.

As described above, the present invention may form a multi-layer flow suitable for the mixture within the mixing fluidic channel and may promote the mixture.

### Example 3

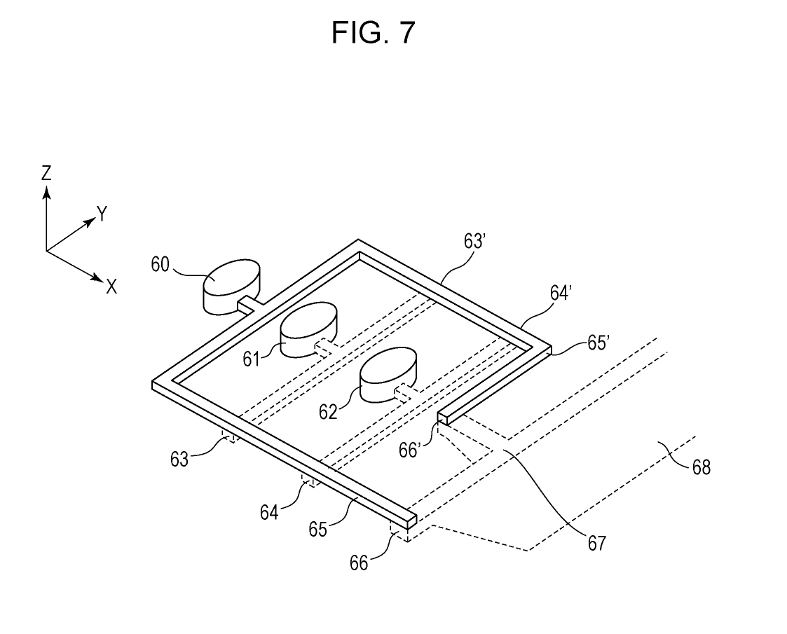

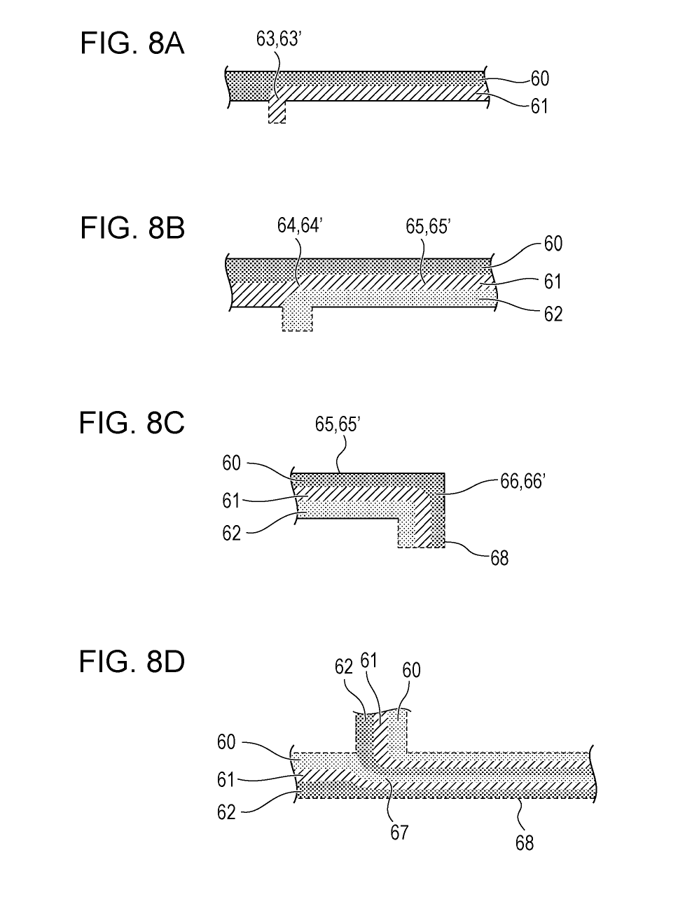

As Example 3, a method of speedily mixing three or more kinds of fluids will be described with reference to FIGS. 7 to 8D.

There is a microfluidic device in which a fluid 60 is disposed in a second inlet, a fluid 61 is disposed in a first inlet and a fluid 62 is disposed in a third inlet. The fluids flowed out of each inlet form a multi-layer flow while flowing toward a mixing fluidic channel 68 and are mixed within the mixing fluidic channel 68. In FIG. 7, a portion represented by a solid line is a fluidic channel formed on the second substrate and a portion represented by a dashed line is a fluidic channel formed on the first substrate. These fluidic channels are connected to each other at junctions 63, 63′, 64, 64′ and ends 66 and 66′. That is, this microfluidic device, in which three kinds of fluids are to be mixed, is constituted by two substrates.

The fluid 61 joins to the fluid 60 at the junction 63 while being displaced in the Z direction to form a two-layer flow in which the fluid 60 is located on the positive side of the Z direction than the fluid 61. The flow of the fluid in this state is illustrated in FIG. 8A. Next, at the junction 64, the fluid 62 joins to the two-layer flow constituted by the fluid 60 and the fluid 61 so as to form a third layer on the negative side of the Z direction. The thus formed three-layer flow flows in the joining fluidic channel 65. The fluids 60, 61 and 62 at this time are illustrated in FIG. 8B.

At the end 66 of the joining fluidic channel 65, the three-layer flow changes its flowing direction to the negative side of the Z direction. The direction in which the three-layer flow is laminated is changed into the X direction and the three-layer flow flows in the mixing fluidic channel 68 to the junction 67. The direction of the three-layer flow at this time is illustrated in FIG. 8C. The fluids which passed the junctions 63′ and 64′ and the joining fluidic channel 65′ also form a three-layer flow. The direction in which the three-layer flow is laminated is changed into the Y direction at the end 66′ and the three-layer flow flows in the mixing fluidic channel 68 to the junction 67.

The flow of the fluid near the junction 67 is illustrated in a cross-sectional view along the XY plane in FIG. 8D. Two three-layer flows formed by the fluids 60, 61 fluid 62 flow toward the junction 67 at which no displacement in the Z direction is carried out. Since the size of the mixing fluidic channel 68 is determined such that the Reynolds number thereof is small, the two three-layer flows join to each other at the junction 67 and form a six-layer flow. When the six-layer flow is formed in the mixing fluidic channel 68, the distance of molecular diffusion necessary for the mixture is reduced and, since the mixing fluidic channel 68 is greater in width (X direction) than in height (Z direction) and thus the interfacial area is kept large: in such an environment, mixture is easy promoted.

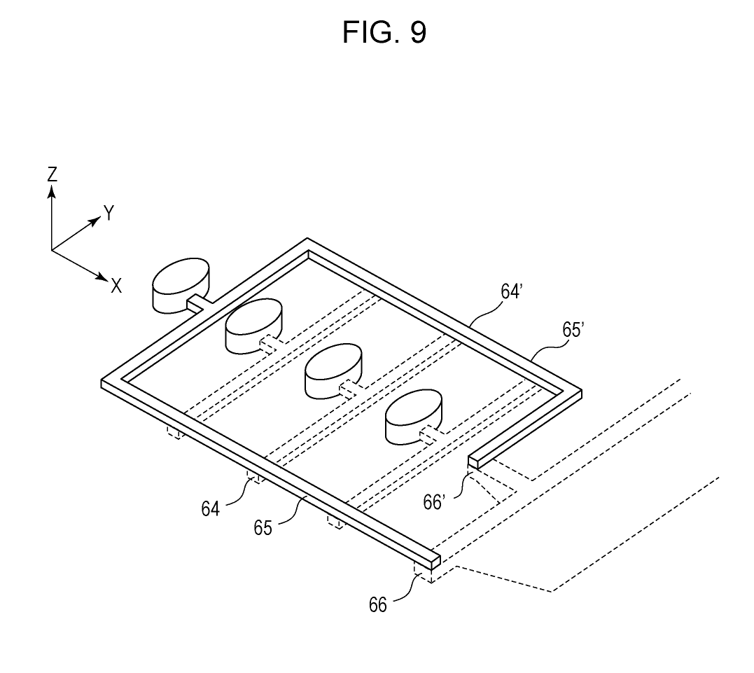

Although the mixture of three kinds of fluids is illustrated in FIG. 7, a greater number of kinds of fluids may be mixed by the following methods. If necessary, a fluidic channel is formed in the first substrate in the direction toward the ends 66 and 66′ from the junctions 64 and 64′, and then the fluidic channel is connected to and joined to the joining fluidic channels 65 and 65′ from the negative side of the Z direction. Inlets and fluidic channels in this case are illustrated in FIG. 9. That is, mixture of four or more kinds of fluids may be achieved only by forming, in the first substrate, a new fluidic channels that has the same structure as that of the fluidic channel in which only the fluid 62 flows in FIG. 7.

As described above, since the present invention is not particularly limited to the mixture of two kinds of fluids, it is not necessary to add the entire structure for the mixture of two kinds of fluids when three or more kinds of fluids are to be mixed. Therefore, the present invention has an effect that an area of the device necessary for the mixture may be reduced. Devices for the mixture of four or five kinds of fluids may be provided by only simple design variation.

### Example 4

As Example 4, liquid-liquid extraction in a microfluidic device will be described as an example with reference to FIG. 1 in order to demonstrate the usefulness of the present invention also in fluids which are immiscible with each other.

A fluid 10 which includes a sample and a fluid 11 from which a sample is to be extracted form a layered flow laminated in the Z direction in a joining fluidic channel 12. The sample is miscible with the fluid 11 and, when brought into contact with the fluid 11, the sample is extracted into the fluid 11. Extraction efficiency depends on a contact interface area between the fluid 10 and the fluid 11: a larger contact interface area has greater extraction efficiency.

Now, the fluids 10 and 11 flowing through the joining fluidic channel 12 as a two-layer flow turn their direction at the end 13, and flow into the mixing fluidic channel 14. At the time of liquid-liquid extraction, the fluid 10 and the fluid 11 are often immiscible with each other: therefore, lamination in the X direction of the two-layer flow is kept also in the mixing fluidic channel 14. However, the mixing fluidic channel 14 is greater in width (X direction) than height (Z direction) and the contact interface area may be set larger than that of the two-layer flow in the joining fluidic channel 12. Therefore, extraction efficiency of the sample into the fluid 11 becomes high as the interfacial area is increased.

The sample is, for example, toluene existing in a solution. If the fluid 10 is a mixture of water and toluene and the fluid 11 is oil, toluene in the solution may be extracted into the oil of the fluid 11.

As described above, the present invention is effective also in other applications than the mixture of fluids. For example, the present invention is effective in reactions in which passing through an interface is necessary, by making the layered flow be formed in the direction in which the interfacial area becomes large.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-175900, filed Aug. 11, 2011, which is hereby incorporated by reference herein in its entirety.

### INDUSTRIAL APPLICABILITY

The present invention may be used in a microfluidic device which carries out chemical reaction and chemical analysis.

1. A fluidic channel device which includes a substrate on which a groove for forming a fluidic channel is provided, the fluidic channel device comprising:
at least two fluidic channels through which fluids flow;
a joining fluidic channel which makes the fluids flowing in the two fluidic channels join to each other and form an interface therebetween; and
a mixing fluidic channel disposed in the downstream of the joining fluidic channel, wherein
a cross sectional area of the mixing fluidic channel with respect to a flowing direction is larger than that of the joining fluidic channel along a direction in which the interface of the fluids becomes large, and
the direction in which the interface becomes large corresponds to a direction in which the groove of the substrate becomes deep.

2. The fluidic channel device according to claim 1, wherein:
the fluidic channel device includes a first substrate on which a groove for forming the mixing fluidic channel is provided, and
the mixing fluidic channel includes a fluidic channel enlargement region which increases its dimension in the depth direction of the groove as the distance from the joining fluidic channel becomes greater.

3. The fluidic channel device according to claim 2, wherein:
the fluidic channel device includes a second substrate, and
a top surface of the fluidic channels enlargement region corresponds to a bottom surface of the second substrate.

4. The fluidic channel device according to claims 3, wherein:
a first fluidic channel is formed in the first substrate and a second fluidic channel is formed in the second substrate,
the second substrate and the first substrate are joined to each other in a manner that an end of the first fluidic channel is connected to the second fluidic channel to form a joining fluidic channel in the second substrate, and
an end of the joining fluidic channel is connected to an end of the fluidic channel formed in the first substrate.

5. The fluidic channel device according to claim 3, wherein:
a first fluidic channel which includes a branching is formed in the first substrate and a second fluidic channel which includes a branching is formed in the second substrate,
one end of the first fluidic channel is connected to the second fluidic channel and forms a second joining fluidic channel in the second substrate,
one end of the second fluidic channel is connected to the first fluidic channel and forms a first joining fluidic channel in the first substrate,
the second substrate and the first substrate are joined to each other in a manner that an end of the first joining fluidic channel is connected to the second joining fluidic channel, and
an end of the second joining fluidic channel is connected to an end of the fluidic channel formed in the first substrate.

6. The fluidic channel device according to claim 3, further comprising, in the joining fluidic channel, a bending fluidic channel for changing a direction of the interface.

7. A method for mixing fluids using a fluidic channel device having at least two fluidic channels and a joining fluidic channel which makes fluids flowing in the two fluidic channels join to each other, the fluidic channel device including a substrate on which a groove for forming a fluidic channel is provided, the method comprising:
introducing fluids into the two fluidic channels;
forming an interface between the fluids in the joining fluidic channels along a direction in which the groove of the substrate becomes deep; and
making the interface become large in the downstream of the joining fluidic channel along a direction in which the groove becomes deep.

8. A fluid control device which controls a fluid using the fluidic channel device according to claim 1, the fluid control device comprising:
a liquid supply unit which supplies a fluid to the fluidic channel device; and
a liquid control unit which controls the fluid in a fluidic channel of the fluidic channel device.

9. A liquid control system, comprising:
the fluidic channel device according to claim 1;
a liquid supply unit which supplies a fluid to the fluidic device; and
a liquid control unit which controls the fluid in a fluidic channel of the fluidic device.

10. The fluidic channel device according to claim 4, further comprising, in the joining fluidic channel, a bending fluidic channel for changing a direction of the interface.
